(19) United States
(12) Patent Application Publication
(10) Pub. No.: US 2005/0191428 A1
(43) Pub. Date: Sep. 1, 2005

(54) Ion-selective electrodes

(76) Inventor: Michael D. Buck, Berthoud, CO (US)

Correspondence Address: Samuel M. Freund;Cochran Freund & Young LLC, Suite 201, 2026 Caribou Drive, Fort Collins, CO, 80525, US

(21) Appl. No.: 11/070,300

(22) Filed: Mar. 1, 2005

Related U.S. Application Data
(60) Provisional application No. 60/548,981, filed on Mar. 1, 2004.
(60) Provisional application No. 60/548,982, filed on Mar. 1, 2004.

(51) Int. Cl. B05D 7/00; G01N 27/26

(52) U.S. Cl. 427/404; 204/416

(57) ABSTRACT

An ion-selective electrode including a water-impermeable, non-conductive substrate; an electrically conductive layer including a metal/metal salt mixture supported on a surface of the substrate; a hydrophobic, conductive intermediate layer in contact with the metal/metal salt layer and including a salt having suitable ionic mobility such that an electrode potential is rapidly established; a layer including an ion-specific ligand in contact with the intermediate layer; and a water-impermeable barrier layer which overlays the layer including the ion-specific ligand such that a portion of this layer is uncovered, and a method for preparing same, is described. The present ion-selective electrode permits rapid, reproducible measurements of ion concentrations to be made without requiring electrode calibration and in the absence of liquid electrolytes.

The present patent application claims the benefit of Provisional Patent Application Ser. No. 60/548,981 filed on Mar. 1, 2004 entitled “Ion-Selective Electrodes” by Michael D. Buck, also known as Mike Buck; Provisional Patent Application No. 60/548,982 filed on Mar. 1, 2004 entitled “Reference Electrode” by Michael D. Buck, also known as Mike Buck; and U.S. patent application Ser. No. ______, filed on Mar. 1, 2005 for “Reference Electrode” by Michael D. Buck, said applications being hereby incorporated by reference herein for all that they disclose and teach.

### FIELD OF THE INVENTION

The present invention relates generally to ion-selective electrodes and, more particularly, to a stable, multi-layer ion-selective electrodes.

### BACKGROUND OF THE INVENTION

An ion-selective electrode (ISE) is an electrode which responds selectively to specific ion species in the presence of other ions. Ion-selective sensors are used in clinical, analytical and industrial laboratories for determining the concentration of particular analytes in solution (typically aqueous solutions). U.S. Pat. No. 5,738,774 for “EVA Containing Ion Selective Membranes And Methods Of Making Same” which issued to Daniel J. Harrison and Aaron Neufeld on Apr. 14, 1998, and “Potentiometric Properties Of Ion-Selective Electrode Membranes Based On Segmented Polyether Urethane Matrices” by Sang Yong Yun et al., Anal. Chem. 69, pages 868-873 (1997) provide examples of membranes suitable for use in ISEs.

U.S. Pat. No. 4,214,968 for “Ion-Selective Electrode” which issued to Charles J. Battaglia et al. on Jul. 29, 1980 describes a multi-layered ion-selective electrode having an ion carrier solvent in contact with the ion-selective membrane to provide ion mobility in the membrane. It is stated that this carrier solvent must be sufficiently hydrophilic to permit rapid wetting of the membrane by an aqueous sample applied thereto to permit ionic mobility across the interface between the sample and the membrane. U.S. Pat. No. 5,472,590 for “lon Sensor” which issued to Koutarou Yamashita et al. on Dec. 5, 1995 describes a layered ion sensor having ion selectivity, where an intermediate layer between the internal solid electrode and the ion selective membrane is capable of keeping water molecules. The intermediate layer includes an organic compound having a water-keeping property and an inorganic compound having a water-keeping property.

It has been found by the present inventor that such hydrophilic layers cause the resulting electrode to become unstable, thereby requiring calibration before use. Moreover, changes in the compositions of the solutions under investigation also require electrode calibration. Additionally, such electrodes demand significant equilibration time with the solutions for which ion concentrations are to be determined.

A liquid junction-free reference electrode system is described in “Solvent-Processible Polymer Membrane-Based Liquid Junction-Free Reference Electrode,” by Hyuk Jin Lee et al., Anal. Chem. 70, pages 3377-3383 (1998). Therein, the authors describe the use of solvent-processible polymer membranes for forming both an ion-selective electrode (ISE) and a reference electrode in a planar solid-state format. A polyvinyl chloride (PVC)/valinomycin-based, potassium-selective electrode is formed by printing a silver electrode on aluminum oxide, and dispensing (screen-printing) a small volume, typically 5 μL, of a solution of high-molecular weight PVC in the plasticizer bis(2-ethylhexyl) adipate into which valinomycin is incorporated, onto the silver electrode and the surrounding dielectric layer. A polyurethane matrix reference site was also formed on the aluminum oxide by incorporating both cation- and anion-exchange sites (for example, potassium tetrakis(p-chlorophenyl)borate and tridodecylmethylammonium chloride) into a polyurethane matrix. The sensors were dried in ambient air for 12 h.

In U.S. Pat. No. 4,571,293 for “Ion Selective Electrode And Method Of Preparation Thereof” which issued to Osamu Seshimoto and Mitsuharu Nirasawa on Feb. 18, 1986, an ion selective electrode for the analysis of sodium ions is described. The electrode includes a support, an electroconductive metal layer, a layer of a water-insoluble salt of the metal, an electrolyte layer which comprises an electrolyte salt of sodium with the same anion as the anion of the water-insoluble salt, the electrolyte layer being substantially free of a binder, and an ion selective layer. The electrolyte layer comprises crystalline electrolyte having a mean size of less than 8 μm, and is formed by coating an aqueous solution of the electrolyte salt on the water-insoluble salt layer and drying the thus coated layer by bringing it in contact with a stream of gas maintained at a temperature of not lower than 40° C. Another method for forming the crystalline electrolyte includes coating a solution of the electrolyte salt in a mixture of water and an organic solvent on the water-insoluble layer and drying the thus coated layer.

Accordingly, it is an object of the present invention to provide a stable, compact ion-selective electrode having reproducible electropotential responses relative to a reference electrode for different solutions containing the selected ion.

Another object of the invention is to provide a stable, compact ion-selective electrode which does not require calibration.

Still another object of the present invention is to provide a stable, compact ion-selective electrode having no internal aqueous electrolyte solution.

Yet another object of the invention is to provide a stable, compact ion-selective electrode having rapid solution equilibration time.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

To achieve the foregoing and other objects, and in accordance with the purposes of the present invention, as embodied and broadly described herein, the electrode for determining the concentration of a selected ion in a solution hereof includes: a water impermeable, non-conductive substrate having a surface; an electrically conductive metal/metal salt layer in contact with the surface of the substrate; a hydrophobic, electrically conductive layer in contact with the metal/metal salt layer and at least partially co-extensive therewith, the conductive layer comprising ions having a mobility effective for establishing a stable potential with the metal/metal salt layer when the electrode is place in the solution; an ion-selective layer in contact with the conductive layer and at least partially co-extensive therewith for selectively responding to ions; and a water-impermeable barrier layer overlaying at least a portion of the ion-selective layer such that the ion-selective layer can be exposed to the solution.

In another aspect of the invention and in accordance with its objects and purposes, the method for generating an electrode for determining the concentration of a selected ion in a solution hereof includes the steps of: forming an electrically conductive metal/metal salt layer on the surface of a water impermeable, non-conductive substrate having a surface; contacting a hydrophobic, electrically conductive layer with the metal/metal salt layer, the conductive layer being at least partially co-extensive with the metal/metal halide layer, wherein the conductive layer comprises ions having a mobility effective for establishing a stable potential with the metal/metal salt layer when the electrode is placed in the solution; contacting an ion-selective layer for selectively responding to ions with the conductive layer, the ion-selective layer being at least partially co-extensive with the conductive layer; and overlaying at least a portion of the ion-selective layer with a water-impermeable barrier layer such that the ion-selective layer can be exposed to the solution.

Benefits and advantages of the present invention include, but are not limited to, stable, ion-selective electrodes which do not require calibration.

### BRIEF DESCRIPTION OF THE DRAWINGS

The accompanying drawings, which are incorporated in and form a part of the specification, illustrate an embodiment of the present invention and, together with the description, serve to explain the principles of the invention. In the drawings:

FIG. 1 is an exploded schematic representation of an embodiment of the ion-selective electrode of the present invention illustrating the substrate, the silver/silver chloride layer, the electrically conductive intermediate layer, the ion selective membrane, and the mask thereof.

FIG. 2 is a top view of the assembled ion-selective electrode shown in FIG. 1 hereof.

FIG. 3 is a side elevation view of the assembled ion-selective electrode shown in FIG. 1 hereof.

FIG. 4 shows the measured potential (volts) as a function of time for the pH electrode described in EXAMPLE 1 hereof, where the horizontal potential sections represent electrode potential measurements in buffer solutions into which the electrode is placed having pH values of 4, 7, and 10, respectively.

FIG. 5 shows the measured potential (volts) as a function of time for the NO₃⁻ electrode described in EXAMPLE 2 hereof, where the horizontal potential sections represent electrode potential measurements in buffer solutions into which the electrode is placed having NO₃⁻ concentration values of 10⁻⁵, 10⁻⁴, 10⁻³, 10⁻², 10⁻¹, and 10⁰ molar, respectively.

### DETAILED DESCRIPTION

Briefly, the present invention includes an ion-selective electrode comprising: a water-impermeable, non-conductive substrate; an electrically conductive layer including a metal/metal salt mixture disposed on a surface of the substrate; a hydrophobic, electrically conductive intermediate layer in contact with the metal/metal salt layer and including a salt having suitable ionic mobility such that an electrode potential is rapidly established when the electrode is placed in a solution containing ions the concentration of which is to be determined; a layer including an ion-specific ligand which covers the intermediate layer, thereby preventing the intermediate layer from coming in contact with the solution; and a water-impermeable barrier layer which overlays at least a portion the other three layers such that a portion of the layer including the ion-specific ligand is uncovered, and electrical connection can be made to the metal/metal salt layer. When electrical contact is made to the metal/metal salt layer, and the ion-selective electrode of the present invention used in cooperation with a reference electrode, a measurement of the concentration of ions in a solution, typically aqueous, with which the ion-selective electrode and the reference electrode are placed in contact, can be made by measuring the potential of the electrochemical cell thus formed. The ion-selective ligand is chosen such that it may bind to the ion for which the concentration is to be determined, thereby enabling accurate measurements to be achieved. The reference electrode may be co-located on the same substrate as the present ion-selective electrode or located elsewhere in the solution.

The present invention also includes a method for generating the ion-selective electrode hereof.

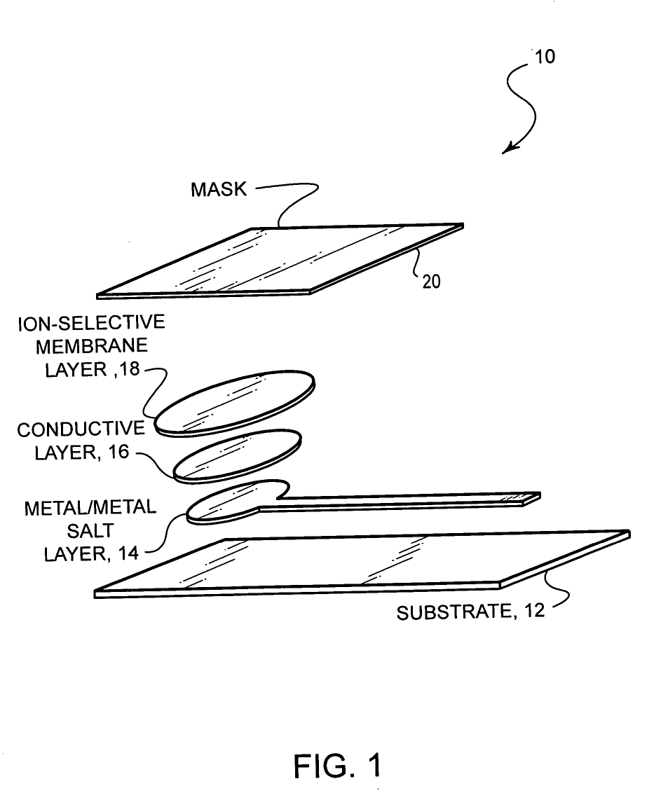

Reference will now be made in detail to the present preferred embodiments of the invention examples of which are illustrated in the accompanying FIGURES. Similar or identical structure is identified using identical callouts. Turning now to FIG. 1, an exploded schematic representation of one embodiment of ion-selective electrode, 10, of the present invention is illustrated. Substrate, 12, includes a nonconductive, water impermeable material to which the electrode layers may adhere. In the ion-selective electrodes tested, thin (0.005 in. to 0.020 in.), substantially planar, flexible substrates of polyester and polystyrene, as examples, were successfully employed.

An electrically conductive metal/metal salt layer, 14, is formed on one surface of this substrate. Silver/silver chloride was found to be suitable, although other metal/metal salt combinations may be employed. Other, non-hygroscopic metal halides such as silver bromide and silver iodide are examples. Binders such as polystyrene and polyester may be used in this layer. Although the thickness of this layer is not critical, typically thicknesses of about 0.0005 in. may be employed.

Hydrophobic electrically conductive layer, 16, is formed on layer 14 and in contact therewith. Typically, this layer includes a soft polymer having a low glass-transition temperature (for example, less than approximately 10° C.), and a salt having suitable ion mobility in the polymer. It is desirable that both ions have equal or substantially equal ion mobility. The anion in the salt is chosen to establish a selected potential between layer 16 and layer 14. By eliminating water from layers 14 and 16, a stable, reproducible and rapidly attainable potential is established which permits electrode 10 to be used without calibration, and remain stable during long periods of storage. Suitable polymers are insoluble in the binder for metal/metal halide layer 14. Conductive layer 16 covers metal/metal salt layer 14 such that layer 14 is not exposed to the solution with which ion-selective electrode 10 is placed in contact. Potassium chloride having crystal particle sizes of less than 5 μm in polymer films having thicknesses between 25 μm and 80 μm has been found to be useful for this purpose. Although polyurethane has been found to be useful for this layer, other polymers and other salts may be utilized. The selection process is facilitated by the fact that if ion mobility is insufficient in the chosen polymer, no potential will be measured at the electrode.

Ion-selective membrane layer 18 is formed on layer 16, thereby preventing layer 16 from coming in contact with solutions in which ion-selective electrode 10 is placed. This layer has a low glass-transition temperature, and may include a plasticized polymer, as an example. Also contained in this layer is an ion-selective material or ligand for a particular ion to be detected. For example, if potassium is to be detected by the electrode, then the ligand in the third layer may be valinomycin or a cyclopolyether, as examples See, for example, U.S. Pat. No. 5,738,774, supra, and U.S. Pat. No. 5,472,590, supra, the teachings of both patents being hereby incorporated by reference herein. For detecting hydrogen, one may use tridodecylamine, as an example. Typical layer thicknesses range between about 0.001 and 0.010 in.

Mask, 20, is formed on layer 18 such that a portion of layer 18 is exposed to the solution under investigation in which electrode 10 is placed. Commercially available vinyl, polyester, and polyurethane adhesive tapes, as examples, have been found to be suitable for this purpose.

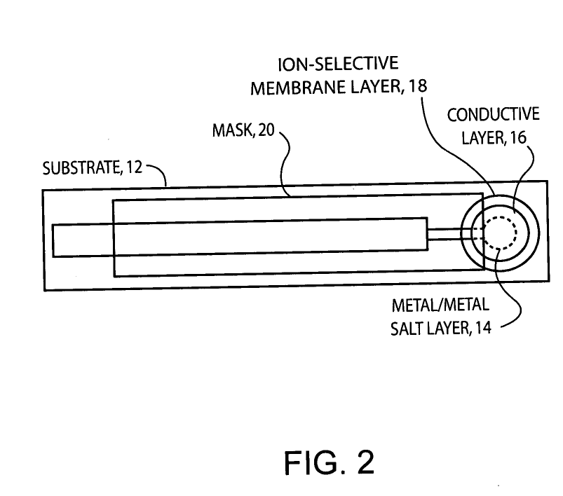

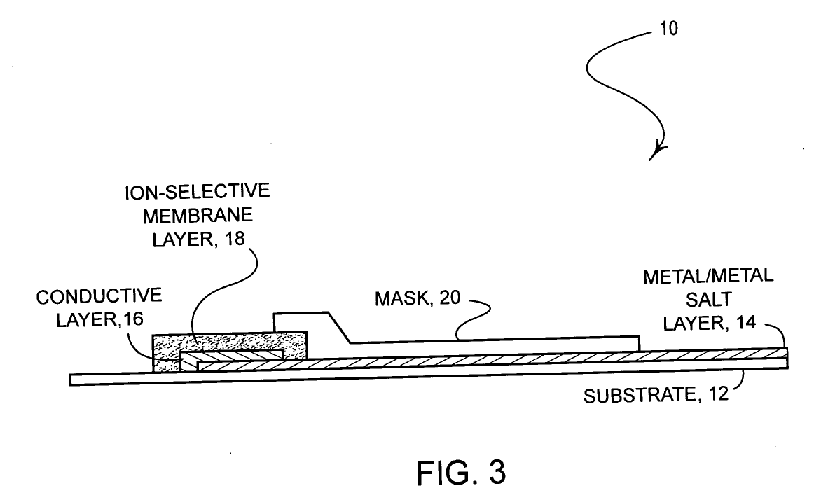

FIG. 2 is a top view of the assembled ion-selective electrode shown in FIG. 1 hereof, while FIG. 3 is a side elevation view of the assembled ion-selective electrode shown in FIG. 1 hereof.

Having generally described the invention, the following EXAMPLES provide more specific details of layer formulations for two ion-selective electrodes.

### EXAMPLE 1

pH Selective Electrode:

(1) Silver/Silver Halide Layer:
(a) A solvent mixture, hereinafter referred to as the Solvent, containing the approximate ratios 37:42:11:10 by volume of: Cyclohexanol (370 mL); Di(propylene glycol)methyl ether acetate (420 mL); γ-butyrolactone (110 mL); and 1,2,3,4-tetrahydronaphthalene (Tetralin) (100 mL), respectively, is used throughout. Cyclohexanone may be substituted for cyclohexanol.
(b) A solution of 15% by weight of polystyrene (melt index 14) (about 75 g) in the Solvent (425 g) is prepared, by adding the polystyrene to the heated and vigorously stirred Solvent. The Solvent is kept below reflux temperature, and several hours of heating and stirring are required to fully dissolve the polystyrene pellets.
(c) Ag/AgCl Powder is prepared by dispersing about 70 g of Ag flake (Technic type 235) in 300 mL of methanol with stirring for about 20 min., or until significant wetting occurs; dissolving approximately 36 g of AgNO₃ in 200 mL of distilled water, and adding this solution to the Ag flake suspension; dissolving about 16 g of KCl in 100 mL of distilled water, and slowly adding this solution to the Ag/AgNO₃ mixture with vigorous stirring. Stirring may be continued for about 15 min. after the addition of the KCl solution. The mixture is filtered to remove the product, and washed with 2 L of water in small portions to remove the KNO₃ present. The product is washed with about 500 mL of methanol to remove the bulk of the water; and the washed product vacuum dried without heating such that few lumps remain, since these are difficult to process into the suspensions used to prepare the layers. The yield is between 99 g and 100 g.
(d) Ag/AgCl suspension:

Approximately 50 g of the 15% by weight polystyrene solution is mixed with about 10 g of Solvent, about 0.3 mL of BYK 065 defoamer, approximately 1.6 mL of BYK 202 dispersing additive, and about 100 g of the Ag/AgCl powder prepared above. The mixture is stirred to wet the powder with the Solvent and polystyrene solution, and the resulting mixture passed twice through a roll mill having feed rolls 0.00005 in. apart. The viscosity of the milled mixture may be adjusted with addition of Solvent as required to produce coatings having uniform consistency, thickness, and drying time, and which can be applied to surfaces using a screening or stenciling process.

(2) Hydrophobic Conductive Layer:
(a) A 15% by weight suspension of KCl in the Solvent is prepared by milling about 45 g of KCl having less than 320 mesh size, approximately 0.5 mL of BYK Anti-Terra-202 wetting agent and 255 g of Solvent for between 4 and 5 days using Zirconia balls.

(b) The coating suspension is prepared by adding 10 g of polyurethane (PU-50) to 50 g of the 15% KCl suspension with stirring, and heating the mixture without refluxing. See, e.g., Sang Yong Yun, et al, supra. for a description of the definition of PU-50 (PU50) and a synthesis thereof. When most of the PU-50 has dissolved, an additional 10 g of PU-50 is added, and heating is continued until the mixture contains little undissolved polymer. The suspension is then cooled and 0.5 mL of BYK-065 Defoamer is added. The mixture is passed through a 3 roll mill having 0.00005 in. roll spacing (one pass has been found to remove the remaining undissolved polymer), and the milled suspension may be thinned with additional solvent to permit the use of the suspension for coating.

It should be mentioned that the PU-50 may be dissolved with lengthy stirring and heating; however, it has been found that it is more efficient and less damaging to the PU-50 to heat until most, but not all of the PU-50 is dissolved, since lengthy heating times have been found to cause the PU-50 to decompose.

(3) pH-Selective Layer:

Approximately 8 g of Polyvinylchloride (PVC) having an inherent viscosity of 0.92 cP is added to a mixture of 37 g of distilled isophorone and about 16 g of Bis(2-ethylhexyl) adipate (DOA) with stirring. The resulting mixture is heated and stirred to dissolve the PVC without refluxing. When the PVC is dissolved, the suspension is cooled to about 50° C., about 0.16 g of Methyldioctadecylamine, about 0.04 g of Potassium p-chlorotetraphenylborate, and approximately 0.2 mL of BYK-065 defoamer are dissolved with stirring. The suspension may be thinned with isophorone for suitable film application, as required.

Note that the Bis(2-ethylhexyl) adipate may be replaced by similar quantities of any of o-nitrophenyl dodecyl ether (Analyst 117, p. 1891 (December 1992)), bis(2-ethyl-hexyl)-sebacate; bis(2-ethyl-hexyl)-adipate (Studia Univ. Babes-Bolyai, Chemia 41, pages 241-246 (1996)), dibutylphthalate; and trihexylphosphate (Talanta 48 23-38 (1999)), and mixtures thereof.

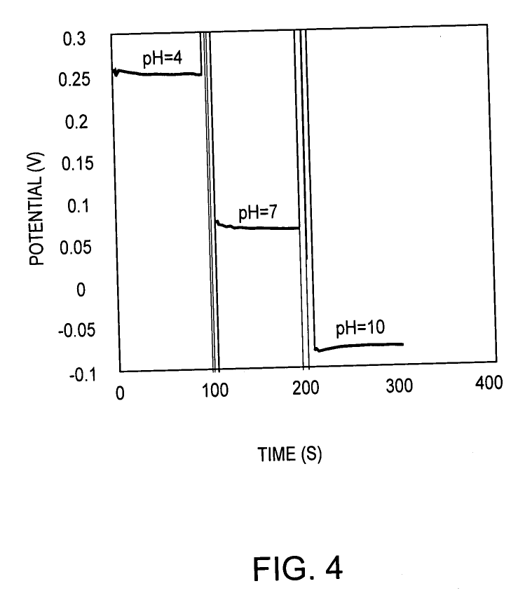

FIG. 4 shows the measured potential (volts) as a function of time for the pH electrode prepared as described hereinabove, where the horizontal potential sections represent measurements of the electrode potential in buffer solutions into which the electrode is placed having pH values of 4, 7, and 10, respectively. Potential measurements are taken about 10 s after immersion in the selected buffers. It is to be noted that the difference in measured potential between pH=4 and pH=7 is 61.4 mV, while that between pH=7 and pH=10 is 60.2 mV. Calculations using the well-known Nernst equation yield 59 mV. It may be noticed that the electrode quickly attains equilibrium potential values.

### EXAMPLE 2

NO₃⁻-Selective Electrode:

NO₃⁻-Selective layer (the remaining layers are identical to those for the pH-sensitive electrode described in EXAMPLE 1 hereinabove):

About 8 g of PVC having an inherent viscosity of 0.92 cP is added to 37 g of distilled isophorone and 16 g of Di(isononylphthalate), and the mixture heated to dissolve the PVC without refluxing. When the PVC is dissolved, the suspension is cooled to about 50° C., and about 1 g of N-Decyl(tri-N-dodecyl)ammonium bromide and approximately 0.2 mL of BYK-065 defoamer are dissolved with stirring. The suspension may be thinned with isophorone for application, as required.

Note that the Di(isononylphthalate) may be replaced by similar quantities of any of dibutyl phthalate; dioctyl phthalate; trixylyl phosphate (Analyst 116, p. 361 (April 1991)), 2-nitrophenyl octyl ether (Analyst 124, pages 877-882 (1999)), and tricresylphosphate (Studia Univ. Babes-Bolyai, Chemia, 41, pages 77-82 (1996)), and mixtures thereof.

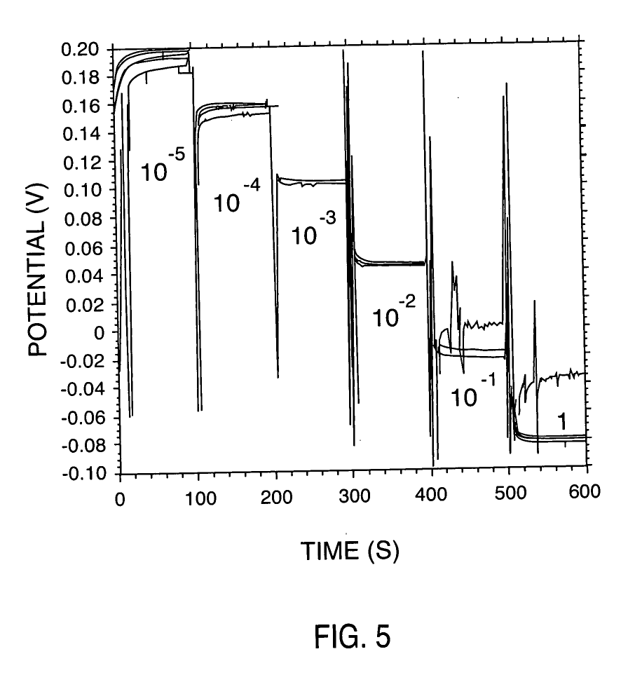

FIG. 5 shows the measured potential (volts) as a function of time for the NO₃⁻ electrode prepared as described hereinabove, where the horizontal potential sections represent electrode potential measurements in buffer solutions into which the electrode is placed having NO₃⁻ concentration values of 10⁻⁵, 10⁻⁴, 10⁻³, 10⁻², 10⁻¹, and 10⁰ molar, respectively. Again, it should be noticed that the electrode quickly attains equilibrium potential values.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. An electrode for determining the concentration of a selected ion in a solution thereof, comprising in combination:
(a) a water impermeable, non-conductive substrate having a surface;
(b) an electrically conductive metal/metal salt layer in contact with the surface of said substrate;
(c) a hydrophobic, electrically conductive layer in contact with said metal/metal salt layer, said conductive layer comprising ions having a mobility effective for establishing a stable potential with said metal/metal salt layer when said electrode is place in contact with the solution;
(d) an ion-selective layer in contact with said conductive layer for selectively responding to ions; and
(e) a water impermeable barrier layer overlaying a portion of said ion-selective layer.

2. The electrode of claim 1, wherein said electrically conductive layer comprises a polymer and an inorganic salt dissolved in said polymer.

3. The electrode of claim 2, wherein the inorganic salt comprises KCl.

4. The electrode of claim 2, wherein the polymer has a glass temperature below 10° C.

5. The electrode of claim 4, wherein the polymer comprises polyurethane.

6. The electrode of claim 1, wherein the metal/metal salt comprises a metal/metal halide.

7. The electrode of claim 6, wherein the metal comprises silver, and the metal halide comprises silver chloride.

8. The electrode of claim 1, wherein the surface of said substrate is substantially planar.

9. The electrode of claim 1, further comprising a reference electrode and means for determining the potential difference between said electrode and said reference electrode.

10. The electrode of claim 9, wherein said reference electrode is formed on said substrate.

11. A method for generating an electrode for determining the concentration of a selected ion in a solution thereof, comprising the steps of:
(a) forming an electrically conductive metal/metal salt layer on the surface of a water impermeable, non-conductive substrate having a surface;
(b) contacting a hydrophobic, electrically conductive layer with the metal/metal salt layer, wherein the conductive layer comprises ions having a mobility effective for establishing a stable potential with the metal/metal salt layer when the electrode is placed in contact with the solution;
(c) contacting an ion-selective layer for selectively responding to ions with the conductive layer; and
(d) overlaying a portion of the ion-selective layer with a water impermeable barrier layer.

12. The method of claim 11, wherein the electrically conductive layer comprises a polymer and an inorganic salt dissolved in said polymer.

13. The method of claim 12, wherein the inorganic salt comprises KCl.

14. The method of claim 12, wherein the polymer has a glass temperature below 10° C.

15. The method of claim 14, wherein the polymer comprises polyurethane.

16. The method of claim 11, wherein the metal/metal salt comprises a metal/metal halide.

17. The method of claim 16, wherein the metal comprises silver, and the metal halide comprises silver chloride.

18. The method of claim 11, wherein the surface of the substrate is substantially planar.

19. The method of claim 11, further comprising the step of measuring the potential difference between the electrode and a reference electrode when the electrode and the reference electrode are placed in a solution containing the selected ions.

20. The method of claim 19, wherein the reference electrode is formed on the substrate.
